(19) United States
(12) Patent Application Publication
(10) Pub. No.: US 2022/0240531 A1
(43) Pub. Date: Aug. 4, 2022

(54) METHOD FOR PRODUCING LOW TRANS-FATTY ACID BUTTER-LIKE FOOD AND LOW TRANS-FATTY ACID BUTTER-LIKE FOOD

(71) Applicant: WISTERIA CO., LTD., Tokyo (JP)

(72) Inventor: Koji Fujiharu, Tokyo (JP)

(21) Appl. No.: 17/621,776

(22) PCT Filed: Dec. 25, 2019
(86) PCT No.: PCT/JP2019/050960

§ 371 Date: Dec. 22, 2021

(30) Foreign Application Priority Data
Jun. 24, 2019 (JP) 2019-116561

(51) Int. Cl. A23D 7/015; A23D 7/05; A23D 7/005

(52) U.S. Cl. CPC A23D 7/015; A23D 7/0056; A23D 7/05

(57) ABSTRACT

The present invention provides a method for producing a low trans-fatty acid butter-like food characterized by including: respectively heating an animal milk and a vegetable processed fat having a melting point of from 30° C. to 35° C., to a temperature equal to or higher than the melting point of the vegetable processed fat; adding from 40% by mass to 60% by mass of the heated vegetable processed fat to from 40% by mass to 60% by mass of the heated animal milk and performing emulsification; cooling an animal milk emulsion obtained by the emulsification; subjecting a creamy substance obtained by the cooling to churning or cavitation, and separating the creamy substance into an aqueous phase and an oil phase; and kneading and homogenizing an oil phase solid obtained by removing the aqueous phase.

### CROSS REFERENCE TO RELATED APPLICATION(S)

This application is a Section 371 National Stage Application of International Application No. PCT/JP2019/050960, filed on Dec. 25, 2019, entitled “METHOD FOR PRODUCING LOW TRANS-FATTY ACID BUTTER-LIKE FOOD AND LOW TRANS-FATTY ACID BUTTER-LIKE FOOD”, which published as WO 2020/261616 A1, on Dec. 30, 2020, not in English, which claims priority to Japanese Patent Application No. 2019-116561, filed on Jun. 24, 2019, the contents of which are incorporated herein by reference in their entireties.

### TECHNICAL FIELD

The present application relates to a method for producing a low trans-fatty acid butter-like food and a low trans-fatty acid butter-like food.

### BACKGROUND ART

Japanese Patent No. 6516940 discloses a method for producing a fat composition in which a hydrous mixture containing butter and milk is heated until a water content becomes less than 1% by mass to prepare a processed butter product, the processed butter product is mixed with edible fat, and a fat composition is produced.

### SUMMARY OF INVENTION

### Technical Problem

In recent years, it has been pointed out that an increase in an intake amount of trans-fatty acids due to a high-fat diet increases LDL cholesterol in the blood, whereby the risk of coronary heart disease is increased, and reduction of an intake amount of trans-fatty acids has been recommended.

The problem of the present application is to use animal milk, such as cow milk, as a raw material, without using butter as a raw material, to produce a food that, although the appearance, impression from use, texture and taste thereof are all butter-like, has a lower content of trans-fatty acids than butter.

### Solution to Problem

A method for producing a low trans-fatty acid butter-like food according to a first embodiment of the present application is characterized by including: respectively heating an animal milk and a vegetable processed fat having a melting point of from 30° C. to 35° C., to a temperature equal to or higher than the melting point of the vegetable processed fat; adding from 40% by mass to 60% by mass of the heated vegetable processed fat to from 40% by mass to 60% by mass of the heated animal milk and performing emulsification; cooling an animal milk emulsion obtained by the emulsification; subjecting a creamy substance obtained by the cooling to churning or cavitation, and separating the creamy substance into an aqueous phase and an oil phase; and kneading and homogenizing an oil phase solid obtained by removing the aqueous phase.

The term “butter-like food” as used in the present application refers to a food which has plasticity resembling that of butter at normal temperature. The term “plasticity” as used herein refers to a physical property that, when a solid is deformed by the application of an external force, the deformation of the solid does not recover. In other words, in a state where a solid does not retain plasticity, the solid breaks without being deformed when an external force is applied thereto, or conversely, the entire solid flows, beyond the deformation applied. The “normal temperature” as used herein refers to a temperature range of from 20° C. to 30° C.

Further, the term “low trans-fatty acid” as used in the present application means that trans-fatty acids are contained at a content that is lower than that of trans-fatty acids ordinarily contained in butter, and also includes, as a concept, the trans-fatty acid content being 0, that is to say, no trans-fatty acids being contained at all.

A second embodiment of the present application is characterized in that, in addition to the features of the first embodiment, the animal milk is cow milk, goat milk, sheep milk, buffalo milk or camel milk.

A low trans-fatty acid butter-like food according to a third embodiment of the present application is characterized in that components derived from an animal milk and fat globules derived from a vegetable processed fat having a melting point of from 30° C. to 35° C. are suspended in a colloidal form, and the low trans-fatty acid butter-like food retains plasticity at least at 20° C.

The definition of the term “plasticity” as used herein is the same as described above. In other words, the low trans-fatty acid butter-like food according to the present embodiment does not break due to being too rigid nor flow due to being too soft at least at 20° C., when an external force is applied thereto. It is noted that the plasticity described above is required to be retained at 20° C., but there is no problem when the plasticity is retained also at a temperature other than that.

A fourth embodiment of the present application is characterized in that, in addition to the features of the third embodiment: the animal milk is cow milk; a fat content is from 70% by mass to 85% by mass; a protein content is from 0.1% by mass to 2.0% by mass; a carbohydrate content is from 1.0% by mass to 5.0% by mass; an ash content is from 0.05% by mass to 0.5% by mass; an α-tocopherol content is from 0.005% by mass to 0.02% by mass; a lactose content is 0.5% by mass or more; a trans-fatty acid content is 1.0% by mass or less; a cholesterol content is 0.1% by mass or less; and a melting point of the fat is from 30° C. to 35° C.

The fat contained in the low trans-fatty acid butter-like food according to the fourth embodiment described above can be separated by a known method, for example, by heating, and collecting the separated supernatant. The melting point of the fat separated as the supernatant can be measured by a known method, for example, by the following method. In other words, one end of a capillary tube is dipped into a sample of the melted fat, to fill the capillary tube with the sample up to a height of about 10 mm. The thus filled capillary tube is left to stand for 24 hours in an environment of 10° C. or lower, or for 1 hour on ice, and the cooled capillary tube is attached closely to a lower portion of a thermometer with a rubber band or by an appropriate method, so that the positions of the respective lower ends of the capillary tube and the thermometer coincide with each other. The thermometer is then immersed in a beaker of an appropriate size (having a capacity of about 600 mL) filled with distilled water, so that the lower end of the thermometer is positioned at a depth 30 mm below the surface of water. While stirring the water in the beaker by an appropriate method, the beaker is heated at a rate of 2° C. per minute at first, and at a rate of 0.5° C. per minute after having reached a temperature 10° C. lower than the expected melting point, and the temperature at which the sample starts to rise in the capillary tube is determined as the melting point of the fat.

Since fat is contained in the animal milk serving as a raw material of the low trans-fatty acid-derived butter-like food of the fourth embodiment described above, fat derived from the animal milk is also contained in the fat contained in the low trans-fatty acid-derived butter-like food. However, the proportion of the fat derived from the animal milk in the fat contained in the low trans-fatty acid-derived butter-like food is vastly smaller than the proportion of fat derived from the vegetable processed fat serving as a raw material. Accordingly, when the melting point of the fat contained in the low trans-fatty acid-derived butter-like food up to the fourth embodiment is measured in the manner described above, the melting point thereof is substantially the same as the melting point of the vegetable processed fat serving as a raw material.

### Advantageous Effects of Invention

Since the respective embodiments of the present application are configured as described above, animal milk, such as cow milk, goat milk, sheep milk, buffalo milk or camel milk, can be used as a raw material, without using butter as a raw material, to produce a food whose appearance, impression from use, texture and taste are all butter-like. This butter-like food, unlike ordinary butter, is a healthy food having a low content of trans-fatty acids.

### BRIEF DESCRIPTION OF DRAWING

FIG. 1 is a flow chart showing the outline of a method for manufacturing a low trans-fatty acid butter-like food in an embodiment of the present application.

### DESCRIPTION OF EMBODIMENTS

The embodiments of the present application will now be described with reference to the drawing.

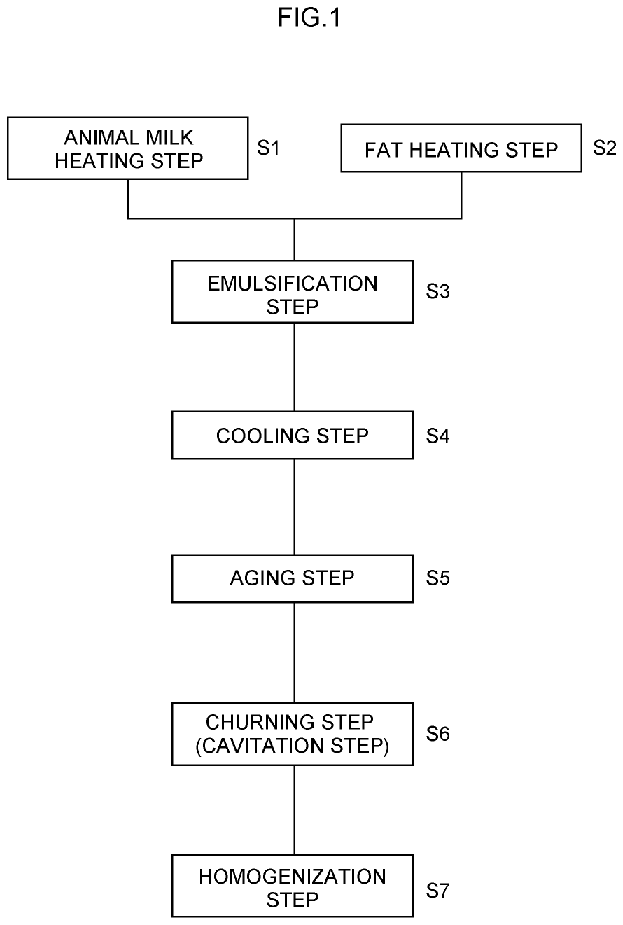

FIG. 1 is a flow chart showing the outline of a method for manufacturing a low trans-fatty acid butter-like food in an embodiment of the present application.

In the method for manufacturing a low trans-fatty acid butter-like food according to the present embodiment, a creamy substance obtained by adding a vegetable processed fat to an animal milk to cause emulsification is subjected to churning or cavitation, and an oil phase solid obtained by removing the aqueous phase is kneaded and homogenized.

The animal milk may be, for example, cow milk, goat milk, sheep milk, buffalo milk or camel milk. However, cow milk is most suitable.

In order to allow, in an animal milk heating step S1, a vegetable processed fat which will be added later as an oil phase to be more easily emulsified with the animal milk (such as cow milk) which will constitute an aqueous phase to form an O/W type emulsion, the animal milk (such as cow milk) is heated to a temperature equal to or higher than the melting point of the vegetable processed fat, for example, to 60° C. If necessary, a hydrophilic emulsifier such as a sucrose fatty acid ester may be added to the animal milk (such as cow milk) in advance, in order to stabilize the emulsified state in an emulsification step S3 to be carried out later.

The “vegetable processed fat” as used herein refers to one obtained by adjusting the melting point of a plant-derived edible oil which is liquid at normal temperature, such as, for example, soybean oil, palm oil, rapeseed oil, cottonseed oil, rice bran oil, safflower oil, peanut oil, sesame oil, linseed oil, olive oil or corn oil, so as to be solid at normal temperature, by an appropriate means (such as hydrogenation or transesterification). The vegetable processed fat is most suitably soybean oil, palm oil or rapeseed oil whose melting point is adjusted to around 32° C.

Such a vegetable processed fat, for example, one having a melting point of about 32° C., is heated in a fat heating step S2, to a product temperature equal to or higher than the melting point of the fat, for example, to 60° C., and liquefied. If necessary, a lipophilic emulsifier such as a glycerin fatty acid ester, a sorbitan fatty acid ester or a propylene glycol fatty acid ester may be added to the vegetable processed fat in advance, in order to stabilize the emulsified state in the emulsification step S3 to be carried out later.

It is noted that the animal milk heating step S1 and the fat heating step S2 are carried out separately as individual steps.

The animal milk heated in the animal milk heating step S1 and the vegetable processed fat heated in the fat heating step S2 are subjected to an emulsification treatment in the emulsification step S3. Specifically, the heated animal milk is first introduced into an emulsification tank, and then the heated vegetable processed fat is introduced into the tank while stirring, little by little, such that air is not mixed thereinto. At this time, it is desired that the amount of the animal milk (such as cow milk) is adjusted, for example, within the range of from 20% by mass to 60% by mass, and preferably from 40% by mass to 60% by mass, with respect to the total amount of the resulting mixture, and the amount of vegetable processed fat (such as palm oil, soybean oil or rapeseed oil) to be introduced is adjusted, for example, within the range of from 40% by mass to 80% by mass, and preferably from 40% by mass to 60% by mass with respect to the total amount. By the emulsification step described above, an O/W type animal milk emulsion is formed. A pressure-type emulsification device, such as a colloid mill, a homomixer or a homogenizer may be used to achieve homogeneous emulsification, in order to stabilize the emulsified state of the O/W type emulsion. However, it is not preferred to enhance the emulsification or to refine the size of emulsified particles more than necessary, in order to facilitate breaking of the emulsification in the churning step or the cavitation step S6 to be carried out later.

When the resulting animal milk emulsion is cooled to a temperature of 15° C. or lower, preferably to 10° C. or lower, in a cooling step S4, a creamy substance having a cream-like appearance is obtained.

The creamy substance obtained in the cooling step is maintained in a cooled state as it is, for 8 or more hours, preferably 10 or more hours, in an aging step S5, and as a result, the fat in the cream is crystallized to be in a stable state.

In other words, fat crystals in the O/W cream can be adjusted to a moderate size, by gradually cooling the O/W cream and subjecting to the aging step. The O/W cream in which the fat crystals have been adjusted to a moderate size by cooling and aging, can be easily foamed in the subsequent churning (cavitation step), thereby improving the efficiency of the churning.

However, it is not preferred to refine the size of the fat crystals by rapid-cooling and scraping, as in the case of manufacturing margarine or the like. Therefore, an apparatus for rapid-cooling and plasticization (scraping heat exchanger, for example, PERFECTOR KONBINATOR; manufactured by WINCKLER & CO., LTD.) used in the production of margarine or the like is not necessary in the cooling step and the aging step.

Next, in the churning step or the cavitation step S6, the creamy substance is vigorously stirred in the tank so that air is mixed thereinto to form air bubbles in the creamy substance. By continuing the stirring, fat globules start to adsorb around the air bubbles formed by foaming of the cream. When the stirring is further continued, the air bubbles in the cream collapse, to cause the fat globules adsorbed on the surfaces of the air bubbles to aggregate with each other, and eventually, the cream separates into an aqueous phase and an oil phase.

The churning step or the cavitation step described above is intended to break the emulsification while foaming the cream, and a viscous paste-like substance obtained as the remaining oil phase solid, after removing the separated aqueous phase, is subjected to a homogenization step S7.

In order to form air bubbles in the creamy emulsified product, to break the emulsification while allowing fat globules to aggregate, and to efficiently collect the paste-like substance containing the oil phase and the remaining aqueous phase, the cavitation step using a cavitation apparatus having a stronger force to foam and to break the emulsification is more preferred, than the churning step using a churning apparatus used in the production of ordinary butter derived from cow milk.

It is noted here that in the production of so-called ordinary butter derived from cow milk, cow milk is first concentrated by centrifugation, reverse osmosis or the like, from a fat content of around 3% to about 40%, and then the resulting O/W type emulsified cream is further inverted to a W/O type emulsified butter by a churning apparatus. During this operation, a large amount of aqueous phase (whey, butter milk, skimmed milk, etc.) is produced and discarded, and an enormous amount of time is required for the separation and concentration.

In contrast, in the production of the butter-like food derived from animal milk in the present disclosure, an enormous time for separating the aqueous phase and concentrating cow milk having a low fat content (around 3%) to butter having a high fat content (around 80%) is not required, and a large amount of aqueous phase is not produced, either. In addition, by forcibly causing foaming to break the emulsification in the churning (cavitation) step, a state in which components derived from animal milk and fat globules derived from vegetable processed fat are suspended in a colloidal form, that is to say, a state in which small air bubbles, aggregated fat globules, and proteins, carbohydrates and ash in the aqueous phase, etc., are suspended in a colloidal form, is formed, differing from the W/O type emulsion structure of butter. As a result, the resulting substance has plasticity under ordinary temperature conditions (for example, at 20° C.), and has a butter-like texture and flavor.

In the homogenization step S7, an excessive moisture is squeezed out from the paste-like substance, and the resultant is kneaded and homogenized in a kneader. In the resulting composition whose hardness has been increased and which has turned into a butter-like state by the above operation, a state in which small air bubbles, aggregated fat globules, and proteins, carbohydrates and ash in the aqueous phase and the like, are suspended in a colloidal form, is formed. This state is different from the W/O type emulsified structure of butter. By forming such a colloidal state, a butter-like food derived from animal milk which has a butter-like appearance, impression from use, texture and taste can be obtained. After the homogenization step, the resulting butter-like food may be formed into a desired shape by molding or the like, and packaged, as appropriate. By using cow milk, goat milk, sheep milk, buffalo milk or camel milk as the animal milk serving as a raw material, it is possible to obtain a low trans-fatty acid butter-like food derived from each animal milk.

It is also possible to obtain a butter-like food derived from animal milk which has a fat-spread-like appearance and impression from use, by increasing the proportion of the animal milk higher than the range described above (for example, to a range of from about 60% by mass to 70% by mass). In this case, the breaking of the emulsification becomes more difficult due to a decreased oil phase content, and thus it is effective to carry out the cavitation step in which the breaking of the emulsification is performed strongly by a cavitation apparatus.

In a case in which from 50% by mass to less than 60% by mass of cow milk serving as the animal milk, and from 40% by mass to 50% by mass of soybean processed fat, palm oil processed fat or rapeseed processed fat, whose melting point has been adjusted to from 30° C. to 35° C., as the vegetable processed fat, are used in the above-described production method as raw materials, a low trans-fatty acid butter-like food is obtained in which a fat content is from 70% by mass to 85% by mass, a protein content is from 0.1% by mass to 2.0% by mass, a carbohydrate content is from 1.0% by mass to 5.0% by mass, an ash content is from 0.05% by mass to 0.5% by mass, an α-tocopherol content is from 0.005% by mass to 0.02% by mass, a lactose content is 0.5% by mass or more, a trans-fatty acid content is 1.0% by mass or less, a cholesterol content is 0.1% by mass or less, and a melting point of the fat is from 30° C. to 35° C. The low trans-fatty acid butter-like food in this case exhibits butter-like appearance, impression from use, texture and taste. The melting point of the fat can be measured after separating the fat by the method described above, and the melting point thereof is substantially the same as the melting point of the vegetable processed fat serving as a raw material.

In the low trans-fatty acid butter-like food described above, the fact that the trans-fatty acid and cholesterol contents are equal to or less than the upper limit values described above is significant as a difference from ordinary butter, and the values thereof may even be 0. Further, although cow milk is similarly used as a raw material, the fact that the lactose content is 0.5% by mass or more is also a remarkable difference with respect to ordinary butter, which contains almost no lactose due to separating an aqueous phase during the production process. Although there is no particular upper limit to the lactose content, in actuality, it does not exceed the lactose content in the cow milk (generally 4.5% by weight) serving as a raw material. Furthermore, α-tocopherol is contained at a higher value than that of ordinary butter, and this is derived from α-tocopherol (vitamin E) that is added as an antioxidant to the vegetable processed fat serving as a raw material.

### EXAMPLES

As raw materials, 5 kg (50% by mass) of unhomogenized cow milk and 5 kg (50% by mass) of a palm oil processed fat having a melting point of 33° C. were used.

First, the unhomogenized cow milk was heated to a product temperature of 60° C. (animal milk heating step S1). Separately, the palm oil processed fat was heated and melted at 60° C. (fat heating step S2). Thereafter, the palm oil processed fat which had been heated and melted was added to the heated unhomogenized cow milk while stirring, and pre-emulsified into an O/W type emulsion (emulsification step S3).

Subsequently, the thus prepared pre-emulsified product was passed through a colloid mill to perform homogenization, then cooled to a product temperature of 15° C. while softly stirring (cooling step S4), and left to stand as it is in a cool place for 15 hours to perform aging (aging step S5).

Next, the emulsified product after aging was transferred to a vertical mixer for confectionery and bread making (30 quarts, manufactured by AICOHSHA MFG. CO., LTD.) equipped with a whipper, and stirred at the highest speed to cause the occurrence of cavitation to break the emulsification, thereby separated into an aqueous phase and an oil phase solid (cavitation step, S6).

Thereafter, the oil phase solid from which the aqueous phase had been separated and removed with a filter cloth was introduced again into the vertical mixer to which a beater had been attached this time, kneaded homogeneously (homogenization step, S7), and then transferred to an appropriate container, to obtain a low trans-fatty acid butter-like food derived from cow milk. The resulting low trans-fatty acid butter-like food was a colloidal composition in which air bubble particles, aqueous phase, proteins, carbohydrates and the like were dispersed in the oil phase, not a W/O type emulsion.

The low trans-fatty acid butter-like food obtained as described above was subjected to a component analysis. The results were as shown in the following Table 1.

TABLE 1

| | Content |
|---|---|
| Component | (% by mass) |
| Moisture | 14.2 |
| Proteins | 0.6 |
| Fat | 81.4 |
| Carbohydrates | 3.7 |
| Ash | 0.1 |
| α-tocopherol | 0.0105 |
| Lactose | 0.65 |
| Trans-fatty acids | 0.44 |
| Cholesterol | 0.016 |

As shown in the Table 1 above, the trans fatty acid content is 0.44% by mass. This is significantly lower than the average value of the trans fatty acid content in ordinary butter, which is 1.951 g/100 g (namely, 1.951% by mass) according to the ““Research Report on Evaluation Basic Data of Trans Fatty Acids in Food” (2007)” by The Food Safety Commission”. Further, the cholesterol content in ordinary butter is 210 mg/100 g (namely, 0.21% by mass) according to the Standard Tables of Food Composition in Japan, 2015 (Seventh Revision) (hereinafter, referred to as “food composition tables”). In contrast, the cholesterol content in the Table 1 above was 0.016% by mass, which is extremely low. The α-tocopherol content in ordinary butter is 1.5 mg/100 g (namely, 0.0015% by mass) according to the food composition tables, whereas the value of the α-tocopherol content in the Table 1 above was about 10 times the value thereof. Further, ordinary butter contains almost no lactose, whereas the lactose content in the Table 1 above was 0.65% by mass. Furthermore, the carbohydrate content in ordinary butter is 0.2 g/100 g (namely, 0.2% by mass) according to the food composition tables, whereas the carbohydrate content in the Table 1 above was 3.7% by mass, which is more than 10 times this amount. From the above, the low trans-fatty acid butter-like food derived from cow milk can be well distinguished from ordinary butter according to analytical values. When the fat of the low trans-fatty acid butter-like food was separated and the melting point thereof was measured, in accordance with the methods described above, the measured melting point roughly coincided with the melting point of the palm oil processed fat as a raw material.

Even if other animal milk, such as goat milk, sheep milk, buffalo milk, camel milk or the like, is used as a raw material in place of the cow milk used as a raw material in the above-described example, a low trans-fatty acid butter-like food can be produced in the same manner.

(7) Evaluation of Plasticity

The plasticity of the low trans-fatty acid butter-like food of the Example, which has been described above, was evaluated as follows. Ordinary butter was used as a Comparative Example.

Specifically, samples of the Example and the Comparative Example were each cut into a cube of about 3 cm, and stored at 5° C., 10° C., 15° C. or 20° C. for 12 hours.

Using a RHEOMETER (RTC2005D-D, manufactured by Rheotech Co., Ltd.), a stress required for deformation of each sample was measured. Specifically, a plunger whose tip is provided with a disk having a diameter of 5 mm was penetrated into each sample to a depth of 15 mm, from the state in which the plunger and the sample were brought into contact, at a penetration speed of 2 cm/min, and the maximum stress (N/cm²) at this point was measured by the rheometer. The results thereof are shown in the following Table 2.

TABLE 2

| | Maximum Stress (N/cm²) | |
|---|---|---|
| Temperature | Example | Comparative Example |
| (° C.) | (Cow Milk) | (Butter) |
| 5 | 19.8 | 55.0 |
| 10 | 13.1 | 51.0 |
| 15 | 3.6 | 23.5 |
| 20 | 1.2 | 12.4 |

From Table 2 above, a decrease in maximum stress accompanying an increase in temperature was confirmed in each of the Example and the Comparative Example. However, in each of the Example and the Comparative Example, since the sample cracked during measurement at 5° C., 10° C. and 15° C., it is considered that the sample does not have plasticity at these temperatures. On the other hand, at 20° C., it was confirmed that deformation by the plunger was maintained and that the sample had plasticity, in each of the Example and the Comparative Example. Therefore, it was confirmed that the low trans-fatty acid butter-like food of the Example exhibited substantially the same behavior as the butter serving as the Comparative Example, in terms of plasticity.

### INDUSTRIAL APPLICABILITY

The present invention can be used in the production of a low trans-fatty acid butter-like food having animal milk, particularly, cow milk, as a raw material.

1. A method for producing a low trans-fatty acid butter-like food, the method comprising:
respectively heating an animal milk and a vegetable processed fat having a melting point of from 30° C. to 35° C., to a temperature equal to or higher than the melting point of the vegetable processed fat;
adding from 40% by mass to 60% by mass of the heated vegetable processed fat to from 40% by mass to 60% by mass of the heated animal milk and performing emulsification;
cooling an animal milk emulsion obtained by the emulsification;
subjecting a creamy substance obtained by the cooling to churning or cavitation, and separating the creamy substance into an aqueous phase and an oil phase; and
kneading and homogenizing an oil phase solid obtained by removing the aqueous phase.

2. The method for producing a low trans-fatty acid butter-like food according to claim 1,
wherein the animal milk is cow milk, goat milk, sheep milk, buffalo milk or camel milk.

3. A low trans-fatty acid butter-like food, wherein components derived from an animal milk and fat globules derived from a vegetable processed fat having a melting point of from 30° C. to 35° C. are suspended in a colloidal form, and the low trans-fatty acid butter-like food retains plasticity at least at 20° C.

4. The low trans-fatty acid butter-like food according to claim 3, wherein:
the animal milk is cow milk;
a fat content is from 70% by mass to 85% by mass;
a protein content is from 0.1% by mass to 2.0% by mass;
a carbohydrate content is from 1.0% by mass to 5.0% by mass;
an ash content is from 0.05% by mass to 0.5% by mass;
an α-tocopherol content is from 0.005% by mass to 0.02% by mass;
a lactose content is 0.5% by mass or more;
a trans-fatty acid content is 1.0% by mass or less;
a cholesterol content is 0.1% by mass or less; and
a melting point of the fat is from 30° C. to 35° C.
